(19) United States
(12) Patent Application Publication
(10) Pub. No.: US 2020/0320619 A1
(43) Pub. Date: Oct. 8, 2020

(54) SYSTEMS AND METHODS FOR DETECTING AND PREVENTING FRAUD IN FINANCIAL INSTITUTION ACCOUNTS

(71) Applicant: LendingPoint LLC, Kennesaw, GA (US)

(72) Inventors: HOUMAN MOTAHARIAN, Glen Rock, NJ (US); MENISH GUPTA, New York, NY (US)

(21) Appl. No.: 16/843,748

(22) Filed: Apr. 8, 2020

Related U.S. Application Data
(60) Provisional application No. 62/830,880, filed on Apr. 8, 2019.

(51) Int. Cl. G06Q 40/02; G06N 20/20; G06K 9/62

(52) U.S. Cl. CPC G06Q 40/025; G06K 9/6296; G06K 9/6256; G06N 20/20

(57) ABSTRACT

Embodiments of the disclosure relate to systems and methods of detecting and preventing fraud in financial institution accounts. In various embodiments, data associated with tradelines may be received from credit reporting bureaus. The data may be used to generate a graph that represents a community of shared tradelines based on matches between attributes associated with tradelines such as account numbers or account type. A set of machine learning models can be trained using a training dataset to provide a set of rules that is optimized for evaluating the graph to detect synthetic identities. The set of rules can be evaluated against one or more nodes in the graph to determine whether an identity represented by each respective node in the graph is a synthetic identity.

### BENEFIT CLAIM

This application claims the benefit under 35 U.S.C. § 119(e) of provisional application 62/830,880, filed Apr. 8, 2019, the entire contents of which are hereby incorporated by reference for all purposes as if fully set forth herein.

### TECHNICAL FIELD

One technical field of the disclosure is computer security. Another technical field is computer systems and data processing methods programmed to perform enterprise fraud management. Yet another technical field is computer-implemented systems and methods for automatically detecting and preventing fraud in financial institution accounts.

### BACKGROUND

The approaches described in this background section are not necessarily prior art to the claims in this application and are not admitted as prior art by inclusion in this section.

An identity may be a collection of digitally stored electronic personal identity information that can be associated with or identify a real individual. Personal identity information may include a social security number or another government number, first name, last name, mailing address, and credit score value such as a FICO score value. A synthetic identity may be a combination of personal identity information for which an identity implied by the data is not associated with a real individual. Synthetic identities can be used to perpetrate fraud in financial institutions. The existence of synthetic identities is a large and growing problem in the financial industry, and computer-implemented techniques for automatically detecting the creation of synthetic identities is a significant technical problem.

There are multiple ways that an individual can create a synthetic identity. As one example, an individual may obtain personal identity information from multiple individuals through a data breach and create a synthetic identity based on a combination of the obtained personal identity information. Using the synthetic identity, the individual may then electronically apply for a line of credit or loan with a financial institution and electronically establish a financial institution account representing the line of credit or loan with the financial institution. Often these steps are executed using end-user computers to interact with websites and SaaS-based account services of the financial institutions.

Once an initial line of credit or loan is approved for the synthetic identity, the initial line of credit may be for a relatively small amount. The individual using the synthetic identity may then associate his or her credit profile with other identities that have previously established credit profiles and/or credit accounts with respective lines of credit. Over time, the credit profile and/or credit associated with the synthetic identity may qualify for high limit lines of credit in respective financial institution accounts at one or more financial institutions. Using the synthetic identity, the individual may continue to open financial institution accounts with lines of credit and increase credit limits until the individual is able to max out the credit lines all at once and vanish, leaving financial institutions with minimal recourse.

Conventional computer systems and programmed methods have difficulty identifying synthetic identities and associated credit profiles and/or credit accounts. One reason for the difficulty is that the associated identity information may be distributed across multiple profiles and credit accounts spanning multiple credit “reporting bureaus. A second reason is that the associated credit data is frequently changed over time. A third reason is that the amount of data required to be analyzed to detect synthetic identities is incredibly vast. Consequently, in the field of financial institution information technology systems, a significant technical problem exists in formulating computerized techniques to efficiently and effectively detect and prevent, under automatic program control, fraud in financial institution accounts.

### SUMMARY

The appended claims may serve as a summary of the invention.

### BRIEF DESCRIPTION OF THE DRAWINGS

In the drawings:

FIG. 1 illustrates a block diagram of an example computer system architecture in accordance with an embodiment of the disclosure.

FIG. 2 illustrates a flow chart of an example flow diagram of an example process in accordance with an embodiment of the disclosure.

FIG. 3 illustrates a graphical user interface (GUI) comprising a graph that represents a community of shared tradelines in accordance with an embodiment of the disclosure.

FIG. 4 illustrates a decision tree that rules can be extracted from in accordance with an embodiment of the disclosure.

FIG. 5 illustrates a GUI that depicts the chronological development of a community of shared tradelines in accordance with an embodiment of the disclosure.

FIG. 6 illustrates a block diagram of a computer system with which an embodiment of the invention may be implemented.

### DESCRIPTION OF EXAMPLE EMBODIMENTS

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form to avoid unnecessarily obscuring the present invention. Embodiments are described in sections according to the following outline:

1. OVERVIEW

2. EXAMPLE SYSTEM IMPLEMENTATION

3. EXAMPLE FUNCTIONAL IMPLEMENTATION

4. IMPLEMENTATION EXAMPLE—HARDWARE OVERVIEW

5. ADDITIONAL DISCLOSURE

### 1. OVERVIEW

Systems and methods are provided for detecting and preventing fraud in financial institution accounts.

Credit bureau report data comprising multiple credit bureau reports that include data associated with a plurality of tradelines is received from one or more credit reporting bureaus. As discussed herein, a tradeline is defined as a record of a financial institution account that has been reported to a credit reporting bureau. One or more tradelines that are associated with an individual's identity typically appear on a credit report of the individual. A tradeline comprises a record of a financial institution account such as a credit account, a loan account, a mortgage account, or any other line of credit account that is associated with an individual's identity. A tradeline may be associated with a variety of attributes such as account identification (ID), account open date, account type, credit limit, high credit amount, open balance amount, financial institution name, equal credit opportunity act designator, payment patterns or any other relevant variable or attribute.

A graph that represents a community of shared tradelines may be generated based on identifying one or more matches between attributes associated with different tradelines. Each node of the graph represents an identity, which may be a real identity or a synthetic identity. Each edge of the graph represents a tradeline that is shared between two identities.

A set of machine learning models can be trained to produce a set of rules that is optimized to detect synthetic identities in the graph. For example, a first machine learning model can be trained using a training dataset that includes attributes associated with tradelines, graph metrics relating to communities of shared tradelines, personal identity information relating to specific individuals, and default data. By training the first machine learning model, an ensemble of decision trees can be generated. A first set of rules can be extracted from the ensemble of decision trees and used as features to train a second machine learning model. By training the second machine learning model, important rules can be identified and extracted from the first set of rules and used to generate a second set of rules that is optimized to detect synthetic identities in the graph.

The second set of rules can be applied against the graph to efficiently determine whether an identity associated with a community of shared tradelines is or may be a synthetic identity. For example, the trained machine learning model may provide a second set of rules that includes the rule: Community size>=3 AND No individual mortgage tradeline AND FICO>700. The second set of rules can be applied to each node in the graph to determine if an identity represented by each respective node is a synthetic identity.

Once a synthetic identity is identified, a line of credit or loan associated with a financial institution account may be denied or restricted. For example, personal identity information associated with the synthetic identity may match personal identity information associated with an application for a line of credit or loan at a financial institution. Upon receiving information regarding the synthetic identity, a financial institution server may deny the application for the line of credit or loan or restrict a line of credit or loan on an existing financial institution account.

Additionally, graphical user interfaces (GUIs) can be displayed that enable the efficient detection of a synthetic identity by an administrator. Such GUIs present information pertinent to identifying synthetic identities in an efficient way, such as in a time-lapse video so that administrators are able to quickly identify fraudulent patterns in data that they normally would not be able to process.

Certain embodiments of the disclosure may achieve the technical effect of improving the operation of credit fraud detection and prevention platforms and systems by leveraging tradeline and related tradeline data from one or more financial institutions as well as one or more credit bureaus. By performing matching between received tradelines to form tradeline communities, sparse data points can be combined and visualized through a graphical user interface so that administrators can quickly and efficiently detect patterns in such data that are indicative of fraudulent behavior, such as synthetic identities.

Additionally, the second set of rules provides optimal efficiency when traversing graphs that represent communities of shared tradelines. The second set of rules is optimized such that a minimum number of generated rules are required to be applied against a graph to accurately detect synthetic identities. For example, the second set of rules is optimized to detect synthetic identities in a graph at a higher accuracy metric than previous implementations. Additionally, the second set of rules is optimized such that fewer rules are required to be applied to the graph to achieve the same or greater synthetic identity detection accuracy compared to previous implementations. For example, a second set of rules that includes four rules can be applied against a graph to detect a 90% likelihood that an identity is synthetic. Prior art approaches that did not employ the disclosed inventions described herein require applying twenty or thirty rules against the same data to achieve the same synthetic identity detection accuracy as the second set of rules. By applying fewer rules against graph data structures to achieve highly accurate results, these techniques reduce the usage of computing power, memory, and/or bandwidth required to traverse the graphs and detect synthetic identities.

Other aspects, features, and embodiments will become apparent from the disclosure as a whole. All embodiments illustrated and described in the disclosure are technical implementations that use computer systems organized and arranged in a particular way and programmed to execute the functions that are described. Throughout the disclosure, the terms “financial institution account”, “tradeline”, or any other “account” refer to a collection of digital data that may be stored in electronic digital data storage devices and may be manipulated by computer processors. This disclosure is not intended to cover or claim abstract concepts, but only technical solutions using computers that are arranged and programmed in the manner that is described. Any interpretation that the disclosure is directed to, covering, reciting, or describing any abstract idea, either expressly or based on the intent of the drafter, is erroneous and unsupported in this disclosure.

The described embodiments provide significant improvements to detecting and preventing fraud in financial institution accounts. Techniques discussed herein utilize a combination of datasets from multiple credit reporting bureaus to detect a higher percentage of synthetic identities with an increased accuracy metric compared to previous techniques. Techniques discussed herein provide graphical user interfaces (GUIs) that display vast amounts of data in a consolidated format so that administrators are able to quickly identify fraudulent patterns in the data that they normally would not be able to process or detect. Additionally, techniques discussed herein include procedures based on machine learning to generate sets of rules that are optimized to efficiently identify synthetic identities in graph data structures.

By generating graph data structures to model cross-bureau tradeline data, generating sets of rules that are optimized and traversing the graph data structures with the sets of rules, and providing improved GUIs to model vast datasets, embodiments can solve the technical problem introduced in this disclosure by providing the technical solution of providing a machine learning optimized synthetic identity detection model with specific and unique ways of displaying data in a format that allows administrators to detect synthetic identity in vast datasets.

### 2. EXAMPLE COMPUTER SYSTEM IMPLEMENTATION

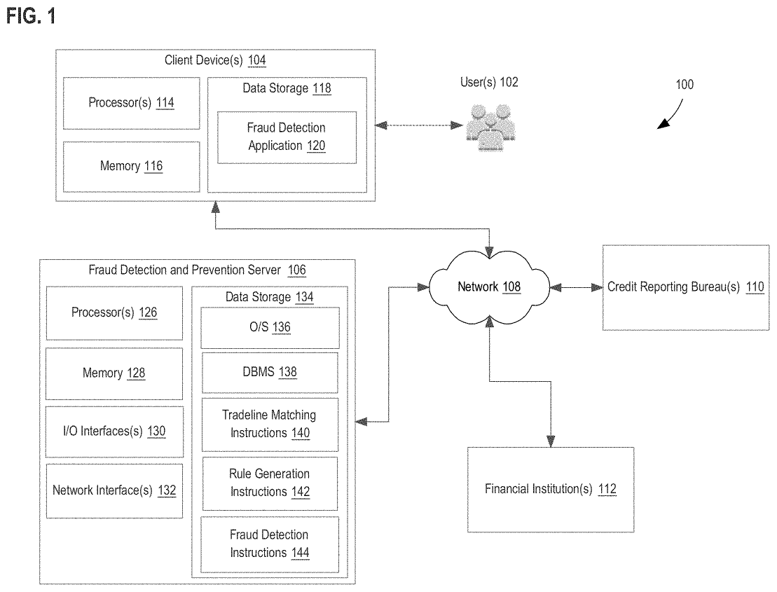

FIG. 1 is a block diagram of an example system architecture in accordance with one or more embodiments of the disclosure. One or more users 102 may interact with a computer system 100, which may include one or more client devices 104 operable by a respective user 102, fraud detection and prevention server 106, one or more financial institution servers 112, and one or more credit reporting bureau server(s) 110. The client devices 104 may include any of the types of devices described through reference to FIG. 1.

Any of the client devices 104, fraud detection and prevention server 106, financial institution servers 112, and credit reporting bureau servers 110 may be configured to communicate with each other and any other component of the system 100 via one or more networks 108. The network 108 may include, but is not limited to, any one or a combination of different types of suitable communications networks such as, for example, cable networks, public networks (e.g., the Internet), private networks, wireless networks, cellular networks, or any other suitable private and/or public networks. Further, the network 108 may have any suitable communication range associated therewith and may include, for example, global networks (e.g., the Internet), metropolitan area networks (MANs), wide area networks (WANs), local area networks (LANs), or personal area networks (PANs). In addition, the network 108 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, satellite communication mediums, or any combination thereof.

Each of the client devices 104 may include one or more processors 114 that may include any suitable processing unit capable of accepting digital data as input, processing the input data based on stored computer-executable instructions, and generating output data. The computer-executable instructions may be stored, for example, in the data storage 118 and may include, among other things, operating system software and application software. The computer-executable instructions may be retrieved from the data storage 118 and loaded into the memory 116 as needed for execution. The processor 114 may be configured to execute the computer-executable instructions to cause various operations to be performed. Each processor 114 may include any type of processing unit including, but not limited to, a central processing unit, a microprocessor, a microcontroller, a Reduced Instruction Set Computer (RISC) microprocessor, a Complex Instruction Set Computer (CISC) microprocessor, an Application Specific Integrated Circuit (ASIC), a System-on-a-Chip (SoC), a field-programmable gate array (FPGA), and so forth.

The data storage 118 may store program instructions that are loadable and executable by the processors 114, as well as data manipulated and generated by one or more of the processors 114 during the execution of the program instructions. The program instructions may be loaded into the memory 116 as needed for execution. Depending on the configuration and implementation of each of the client devices 104, the memory 116 may be volatile memory (memory that is not configured to retain stored information when not supplied with power) such as random access memory (RAM) and/or non-volatile memory (memory that is configured to retain stored information even when not supplied with power) such as read-only memory (ROM), flash memory, and so forth. In various implementations, the memory 116 may include multiple different types of memory, such as various forms of static random access memory (SRAM), various forms of dynamic random access memory (DRAM), unalterable ROM, and/or writeable variants of ROM such as electrically erasable programmable read-only memory (EEPROM), flash memory, and so forth.

Various program modules, applications, or the like may be stored in data storage 118 that may comprise computer-executable instructions which, when executed by one or more of the processors 114, cause various operations to be performed. The memory 116 may have loaded from the data storage 118 one or more operating systems (O/S) that may provide an interface between other application software (e.g., dedicated applications, a browser application, a web-based application, a distributed client-server application, etc.) executing on the mobile device 104 and the hardware resources of the mobile device 104. More specifically, the O/S may include a set of computer-executable instructions for managing the hardware resources of the client devices 104 and for providing common services to other application programs (e.g., managing memory allocation among various application programs). The O/S may include any operating system now known or which may be developed in the future including but not limited to any mobile operating system, desktop or laptop operating system, mainframe operating system, or any other proprietary or open-source operating system.

The data storage 118 may additionally include various other program modules that may include computer-executable instructions for supporting a variety of associated functionality. For example, the data storage 118 may include one or more applications, including fraud detection applications 120. In the embodiment shown, fraud detection application 120 may include computer-executable instructions which, in response to execution by one or more processors 114, cause the performance of various functions associated with system 100. For example, the execution of fraud detection application 120 may communicate with fraud detection and prevention server 106 to cause various instructions stored in fraud detection and prevention server 106 to execute. Execution of fraud detection application 120 may also cause receiving data from fraud detection and prevention server 106, and in response causing the generation and displaying of a graphical user interface (GUI) on the client device 104, as further discussed herein.

The one or more credit reporting bureau(s) servers 110 may be one or more servers associated with one or more credit bureaus that possess data associated with various tradelines. A credit reporting bureau server 110 may provide credit bureau report data. Credit bureau report data may include a plurality of credit bureau reports. Each credit bureau report includes data associated with an identity. Data associated with an identity may include data associated with one or more tradelines related to the identity and personal identity information corresponding to the identity. Data associated with one or more tradelines may include one or more attributes associated with a tradeline. Examples of such attributes include: account ID, an account creation date, an account type, an account credit limit payment amount, account open date, account close date, financial institution name, current balance, account type, high credit amount, equal credit opportunity act designator, last verification date, high credit amount, last payment date, payment history, portfolio type, number of times payment was late, frequency of payments. Personal identity information may include information such as a social security number, first name, last name, mailing address, FICO score.

The one or more financial institution servers 112 may be one or more servers associated with one or more financial institutions that possess data associated with various tradelines. A financial institution server 112 may provide credit bureau report data. Credit bureau report data may include a plurality of credit bureau reports. Each credit bureau report includes data associated with an identity. Data associated with an identity may include data associated with one or more tradelines related to the identity and personal identity information corresponding to the identity. Data associated with one or more tradelines may include one or more attributes associated with a tradeline. Examples of such attributes include: account ID, an account creation date, an account type, an account credit limit payment amount, account open date, account close date, financial institution name, current balance, account type, high credit amount, equal credit opportunity act designator, last verification date, high credit amount, last payment date, payment history, portfolio type, number of times payment was late, frequency of payments. Personal identity information may include information such as a social security number, first name, last name, mailing address, FICO score. Financial institution server 112 may also be configured to programmatically cause a line of credit or loan associated with a financial institution account to be denied or restricted in response to receiving a message or command from fraud detection and prevention server 106.

The fraud detection and prevention server 106 may include one or more processors 126, and one or more memories 128 (referred to herein generically as memory 128). The one or more processors 126 may include any suitable processing unit capable of accepting digital data as input, processing the input data based on stored computer-executable instructions, and generating output data. The computer-executable instructions may be stored, for example, in the data storage 134 and may include, among other things, operating system software and application software. The computer-executable instructions may be retrieved from the data storage 134 and loaded into the memory 128 as needed for execution. The one or more processors 126 may be configured to execute the computer-executable instructions to cause various operations to be performed. The one or more processors 126 may include any type of processing unit including, but not limited to, a central processing unit, a microprocessor, a microcontroller, a Reduced Instruction Set Computer (RISC) microprocessor, a Complex Instruction Set Computer (CISC) microprocessor, an Application Specific Integrated Circuit (ASIC), a System-on-a-Chip (SoC), a field-programmable gate array (FPGA), and so forth.

The data storage 134 may store program instructions that are loadable and executable by the one or more processors 126, as well as data manipulated and generated by the one or more processors 126 during the execution of the program instructions. The program instructions may be loaded into the memory 128 as needed for execution. Depending on the configuration and implementation of the one or more fraud detection and prevention servers 106, the memory 128 may be volatile memory (memory that is not configured to retain stored information when not supplied with power) such as random access memory (RAM) and/or non-volatile memory (memory that is configured to retain stored information even when not supplied with power) such as read-only memory (ROM), flash memory, and so forth. In various implementations, the memory 128 may include multiple different types of memory, such as various forms of static random access memory (SRAM), various forms of dynamic random access memory (DRAM), unalterable ROM, and/or writeable variants of ROM such as electrically erasable programmable read-only memory (EEPROM), flash memory, and so forth.

The fraud detection and prevention server 106 may further include additional data storage 134, such as removable storage and/or non-removable storage including, but not limited to, magnetic storage, optical disk storage, and/or tape storage. Data storage 134 may provide non-volatile storage of computer-executable instructions and other data. The memory 128 and/or the data storage 134, removable and/or non-removable, are examples of computer-readable storage media (CRSM).

The fraud detection and prevention server 106 may further include network interfaces 132 that facilitate communication between the one or more fraud detection and prevention servers 106 and other devices of the illustrative system 100 (e.g., client devices 104, fraud detection and prevention servers 106, etc.) or application software via the network 108. The fraud detection and prevention server 106 may additionally include one or more respective input/output (I/O) interfaces 130 (and optionally associated software components such as device drivers) that may support interaction between a user and a variety of I/O devices, such as a keyboard, a mouse, a pen, a pointing device, a voice input device, a touch input device, gesture detection or input device, a display, speakers, a camera, a microphone, a printer, and so forth.

Referring again to the data storage 134, various program modules, applications, or the like may be stored therein that may comprise computer-executable instructions which, when executed by the one or more processors 126, cause various operations to be performed. The memory 128 may have loaded from the data storage 134 one or more operating systems (O/S) 136 that may provide an interface between other application software (e.g., dedicated applications, a browser application, a web-based application, a distributed client-server application, etc.) executing on the one or more investment app servers 106 and the hardware resources of the investment app server(s) 106. More specifically, the O/S 136 may include a set of computer-executable instructions for managing the hardware resources of the fraud detection and prevention servers 106 and for providing common services to other application programs (e.g., managing memory allocation among various application programs). The O/S 136 may include any operating system now known or which may be developed in the future including but not limited to any mobile operating system, desktop or laptop operating system, mainframe operating system, or any other proprietary or open-source operating system.

The data storage 134 may further include one or more database management systems (DBMS) 138 for accessing, retrieving, storing, and/or manipulating data stored in one or more datastores. The DBMS 138 may use any of a variety of database models (e.g., relational model, object model, etc.) and may support any of a variety of query languages.

The data storage 134 may additionally include various other computer-executable instructions for supporting a variety of associated functionality. For example, the data storage 134 may include tradeline matching instructions 140, rule generation instructions 142, and fraud detection instructions 144.

The tradeline matching instructions 140 may include computer-executable instructions that in response to execution by the one or more processors 126 cause operations to be performed including receiving data associated with one or more tradelines from credit reporting bureaus 110 and/or financial intuitions 112. The data may be received from multiple, independent credit bureaus. The received data may include attributes associated with each tradeline, personal identity information linked to or associated with each tradeline, and metadata associated with each tradeline. Such data may be stored in a storage device, such as data storage 134. The operations to be performed may also include determining matches between attributes associated with tradelines. Operations to be performed may also include creating communities of tradelines based on matches between attributes associated with different tradelines. Such operations may include generating graph data structures that represent communities of shared tradelines. In various embodiments, tradeline matching instructions 140 may communicate with graph database management systems including, without limitation, Neo4j, TigerGraph, Dgraph, and Janus Graph to generate, modify, and process the graphs. Further operations to be performed may also include calculating graph metrics based on the generated graphs. Graph metrics may include an amount of tradelines in a community, velocity of community growth, number of potential synthetic identities in a community, average age of a community, average age of the tradelines in the community.

The rule generation instructions 142 may be configured to access external artificial intelligence libraries via network 108. In an embodiment, external artificial intelligence libraries implement neural network functions, classifier functions, natural learning processing, or other machine learning functions and may be imported, statically or dynamically linked, called or programmatically integrated into or coupled to the rule generation instructions 142 using other means. In an embodiment, external artificial intelligence libraries comprise the TensorFlow system or RuleFit system, which are publicly available under open-source licensing.

The rule generation instructions 142 may be configured to obtain a copy of a training dataset stored in data storage 134 and use it to train a set of machine learning models. Training the set of machine learning models may comprise using the training dataset to train a first machine learning model to generate an ensemble of decision trees. The rule generation instructions 142 may be configured to extract a first set of rules from the ensemble of decision trees and use the first set of rules as features to train a second machine learning model. The second machine learning model may be used to analyze the first set of rules extracted from the first machine learning model and generate a second set of rules that is optimized for evaluating the graph to detect synthetic identities. The second set of rules can be used by the fraud detection instructions 144 to detect synthetic identities.

In some embodiments, a training dataset may include attributes associated with tradelines, graph metrics relating to communities of shared tradelines, personal identity information relating to specific individuals, and default data.

In some embodiments, the rule generation instructions 142 may be configured to receive and store a set of rules, the set of rules including one or more rules that are optimized using machine learning techniques as discussed herein to detect synthetic identities.

The fraud detection instructions 144 may include computer-executable instructions that in response to execution by the one or more processors 126 cause operations to be performed including determining that a community of shared tradelines may be associated with one or more synthetic identities by traversing graphs and applying rules to data associated with the graphs. Further operations to be performed may include generating and causing displaying graphical user interfaces (GUI), as further discussed herein. The operations to be performed may also include transmitting messages, notifications, recommendations, and/or alerts to other computing devices of system 100. Such messages, notifications, recommendations, and/or alerts may be transmitted using various application programming interfaces (APIs) that may be associated with various computing devices of system 100. In some embodiments, such messages, notifications, recommendations, and/or alerts may cause programs, routines, or other computer-implemented functions to execute at the receiving computing device. Fraud detection instructions 144 may also provide an API for external computing devices to communicate with fraud detection instructions 144.

Any of the components of the system 100 and associated architecture may include alternate and/or additional hardware, software, or firmware components beyond those described or depicted without departing from the scope of the disclosure. For example, hardware, software, or firmware components depicted or described as forming part of any of the illustrative components of the system 100, and the associated functionality that such components support, are merely illustrative and that some components may not be present or additional components may be provided in various embodiments. While various program modules have been depicted and described with respect to various illustrative components of the system 100, the functionality described as being supported by the program modules may be enabled by any combination of hardware, software, and/or firmware. Each of the above-mentioned modules may, in various embodiments, represent a logical partitioning of supported functionality. This logical partitioning is depicted for ease of explanation of the functionality and may not be representative of the structure of hardware, software, and/or firmware for implementing the functionality. The functionality described as being provided by a particular module may, in various embodiments, be provided at least in part by one or more other modules. Further, one or more depicted modules may not be present in certain embodiments, while in other embodiments, additional modules not depicted may be present and may support at least a portion of the described functionality and/or additional functionality. Further, while certain modules may be depicted and described as submodules of another module, in certain embodiments, such modules may be provided as independent modules.

The system 100 is one example only. Numerous other operating environments, system architectures, and device configurations are within the scope of this disclosure. Other embodiments of the disclosure may include fewer or greater numbers of components and/or devices and may incorporate some or all of the functionality described with respect to the illustrative system 100, or additional functionality.

### 3. EXAMPLE FUNCTIONAL IMPLEMENTATION

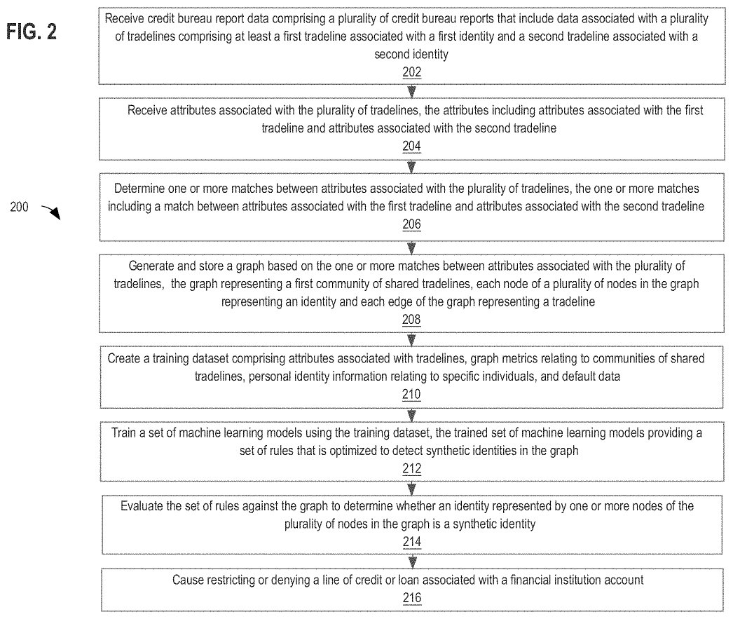

FIG. 2 shows an example flowchart of a method for detecting and preventing fraud in a financial institution account.

Although the steps in FIG. 2 are shown in one example order, the steps of FIG. 2 may be performed in any order and are not limited to the order shown in FIG. 2. Additionally, some steps may be optional, may be performed multiple times, or may be performed by different components. All steps, operations, and functions of a flow diagram that are described herein are intended to indicate operations that are performed using programming in a special-purpose computer or general-purpose computer, in various embodiments. Each flow diagram and block diagram is presented at the same level of detail that persons skilled in the applicable technical fields use to communicate with one another about plans, specifications, algorithms, and data structures as a basis for programming implementations to solve the applicable technical problems, while also applying their accumulated knowledge and skill of computer architecture, programming, and engineering techniques. Each flow diagram in this disclosure provides a guide, plan, or specification of an algorithm for programming a computer to execute the functions that are described.

In step 202, credit bureau report data is received. Credit bureau report data includes a plurality of credit bureau reports. Each credit bureau report may be received from one or more different credit reporting bureaus. Each credit bureau report includes data associated with an identity. Data associated with an identity may include data associated with one or more tradelines related to the identity and personal identity information corresponding to the identity. In some embodiments, multiple bureau reports associated with a particular identity may be received from multiple different credit reporting bureaus and combined into a single dataset. For example, a first credit bureau report for the particular identity may be received from Experian credit reporting bureau. A second credit bureau report the particular identity may be received from TransUnion credit reporting bureau. The first credit bureau report may include different or additional data associated with tradelines that are related to the particular identity. For example, the second credit bureau report may include data associated with one or more tradelines that are not included in the first credit bureau report. Data associated with one or more tradelines that correspond to the same identity and are received from different credit report reporting may be combined into a single dataset that is associated with the identity.

In one example, credit bureau report data may include over a million credit bureau reports where each credit bureau report may include data corresponding to 20-30 tradelines.

In step 204, attributes associated with a plurality of tradelines are received. Attributes that are received include attributes associated with the first tradeline and attributes associated with the second tradeline. In some embodiments, the attributes may be attributes reported by various credit bureaus. In some embodiments, the attributes may be attributes provided by various lending institutions. Examples of such attributes may include, but are not limited to: account identification (ID), an account creation date, an account type, an account credit limit amount, account open date, account close date, current balance, account type, high credit amount, equal credit opportunity act designator, last verification date, high credit amount, last payment date, payment history, portfolio type, number of times payment was late, frequency of payments.

In step 206, one or more matches between attributes associated with the plurality of tradelines are determined. The one or more matches include one or more matches between attributes associated with the first tradeline and attributes associated with the second tradeline. In some embodiments, determining a match between attributes may involve determining that attributes of two or more tradelines are equivalent. For example, a match between the first tradeline and the second tradeline may be identified if it is determined that the first tradeline is associated with an account creation date of ‘9/1/18’ and the second tradeline is associated with an account creation date of ‘9/1/18’.

In some embodiments, a match may be determined through similarities between two or more tradelines with respect to any other type of data associated with the tradelines. For example, a match between a first tradeline and a second tradeline may be identified if it is determined that the two tradelines are associated with the same personal identity information such as a last name.

In some embodiments, matches may be made between any number of tradelines. Tradelines may have matches with multiple other tradelines, or tradelines may only match with one other tradeline.

In step 208, a first community of shared tradelines is created by generating and storing a graph data structure based on the one or more matches between attributes associated with the plurality of tradelines. The one or more matches includes a match between attributes associated with the first tradeline and attributes associated with the second tradeline. The graph data structure, referred to herein as a ‘graph’, includes a plurality of nodes and one or more edges. For a community of shared tradelines, each node of a graph represents an identity and corresponding personal identity information. In some embodiments, a node of a graph is created by hashing personal identity information associated with an identity to generate a unique identifier (ID) for the node. A mapping may be stored that associates the hash of a unique identifier to the personal identity information of the corresponding identity such as full SSN, first name, last name, and address, FICO score.

Each edge of a graph represents a tradeline that is shared between two nodes. An edge between two nodes is created based on the one or more matches between tradelines determined in step 206. For example, if a first identity represented by a first node is associated with a tradeline that shares a match with a tradeline that is associated with a second identity represented by a second node, an edge is created between the first node and the second node. In various embodiments, graph database management systems including, without limitation, Neo4j, TigerGraph, Dgraph, and Janus Graph can be utilized to create, modify, and process the graphs.

In some embodiments, one or more graph metrics may be calculated based on a graph. Example graph metrics may include amount of tradelines in a community, velocity of community growth, number of potential synthetic identities in a community, average age of a community, average age of the tradelines in the community.

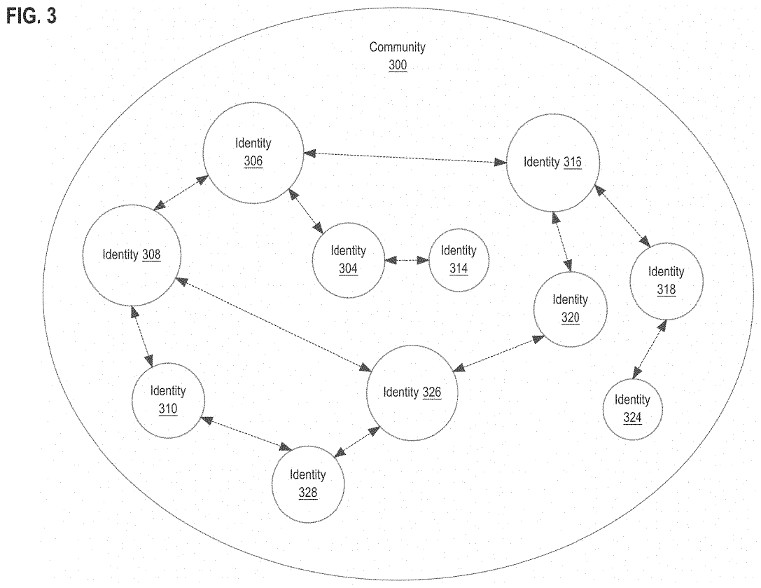

In some embodiments, one or more communities of shared tradelines may be visualized through a graphical user interface (GUI). FIG. 3 illustrates a GUI comprising a graph that represents a community of shared tradelines. Each node in community 300 corresponds to an identity that is associated with personal identity information. For example, community 300 includes identities 304-310, 314-320 and 324-328. A match between two tradelines is represented by an edge that attaches two nodes that share the respective tradelines. For example, the edge between identity 306 and identity 316 indicates a match between tradelines associated with each identity 306, 316. The relative size of a node in community 300 is indicative of how many tradelines the respective node shares with other nodes. For example, identity 306 has three edges attached to it, the edges indicating that identity 306 shares three tradelines with other identities of the community. Because it is unusual for an identity to share multiple tradelines with other identities, the relative size of a node in community 300 may be indicative that the identity associated with the node is a synthetic identity. Thus, graphically visualizing communities of shared tradelines may be useful for an administrator to quickly and efficiently detect identities of tradelines that may be associated with synthetic identities.

In some embodiments, it is determined that a particular tradeline of the first community of shared tradelines is shared between family members. For example, the graph representing the first community of shared tradelines may be traversed to determine that two nodes sharing an edge in the graph are associated with the same personal identity information such as a last name and/or an address. Because a parent sharing a tradeline with their child or a husband sharing a tradeline with their wife is not indicative of a synthetic identity, the graph may be modified to remove edges from the graph that represent relationships between nodes that represent identities from the same family. After any edges are removed from the graph, the graph may be further processed to remove nodes that no longer share any edges with any other nodes of the graph.

In step 210, a training dataset is created that comprises attributes associated with tradelines, graph metrics relating to communities of shared tradelines, personal identity information relating to specific individuals, and default data.

In an embodiment, a training dataset may include features such as size of a community of shared tradelines, a number of mortgage tradelines associated with a node, a number of auto tradelines associated with a node, a number of total authorized tradelines associated with a node, a number of initial authorized tradelines associated with a node, a number of total individual tradelines associated with a node, a number of initial individual tradelines associated with a node, a number of inquiries on tradelines of type “Personal Finance” associated with a node, a number of distinct SSN associated with a node associated with a node, FICO score associated with a node, an average limit on initial authorized tradelines associated with a node, a depth of credit profile associated with a node, a debt to income ratio associated with a node, a payment to income ratio associated with a node, income associated with a node, utilization on tradelines of type “Revolving” associated with a node, a length of individual credit profile to length of complete credit profile ratio associated with a node. A training dataset may also include a target that specifies default data such as early term default value or charge off represented by a binary value (0/1). In one example, early term default value or charge off may be defined as when an individual defaults on payments or their account is charged off within three months of a loan or line of credit origination date.

In step 212, a set of machine learning models is trained using the training dataset. The set of machine learning models comprises one or more machine learning models that provide a set of rules that can be applied to the graph to efficiently detect synthetic identities.

In an embodiment, a first machine learning model is trained using the training dataset. An algorithm used to train the first machine learning model may comprise a gradient boosting (GBM) algorithm or random forest (RF) algorithm. The GBM or RF algorithm used to train the first machine learning model is used to fit or generate an ensemble of decision trees comprising one or more decision trees by regressing or classifying the targets from the training dataset with the features from the training dataset. Technical details and examples of GBM are taught in the related reference “Gradient Boosting Classifier,” at https://scikit-learn. org/stable/modules/generated/sklearn.ensemble.GradientBoostingClassifier.html.

In an embodiment, the first machine learning model is trained using the following hyperparameters: loss: deviance, learning_rate: 0.1, n_estimators: 100, subsample: 1.0, criterion: friedman_mse, min_samples_split: 2, min_samples_leaf: 1, min_weight_fraction_leaf: 0.0, max_depth: 4, min_impurity_decrease: 0.0, min_impurity_split: None, init: None, random_state: None, max_features: None, verbose: 0, max_leaf nodes: None, warm_start: False, validation_fraction: 0.1, n_iter_no_change: None, tol: 0.0001, ccp_alpha: 0.0.

Once the first machine learning model is trained, a first set of rules comprising a plurality of rules is extracted from the ensemble of decision trees generated by the first machine learning model. The first set of rules may be extracted from each decision tree of the ensemble of decision trees using any applicable computerized technique such as by running a script or program to record the rules encoded in one or more data structures that represent the ensemble of decision trees.

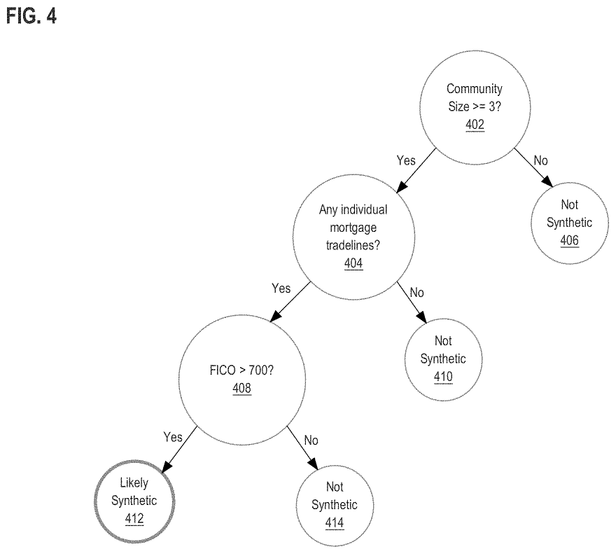

FIG. 4 illustrates a decision tree from which rules can be extracted. In one embodiment, for example, node 402 is configured to determine if a community of shared tradelines has a size >=3. If the rule is satisfied, then node 402 branches to node 404, and if the rule is not satisfied then node 402 branches to node 406. Node 404 is configured to determine whether there are any individual mortgage tradelines in the community of shared tradelines. If the rule is satisfied, then node 404 branches to node 408, and if the rule is not satisfied then node 404 branches to node 410. Node 408 is configured to determine whether a FICO score associated with an identity is >700. If the rule is satisfied, then node 408 branches to node 412, and if the rule is not satisfied then node 408 branches to node 414.

Nodes 406, 410, 412, 414 are leaf nodes that indicate an output as a result of the decision nodes that were traversed to reach the respective node. In this example, nodes 406, 410, 414 have an output of ‘Not Synthetic’. The output of ‘Not Synthetic’ indicates that the identity that the decision tree logic is being applied against is likely not a synthetic identity. Node 412 has an output of ‘Likely Synthetic’. ‘Likely Synthetic’ indicates that the identity that the decision tree logic is being applied against is likely a synthetic identity.

Rules can be extracted from a decision tree by traversing the decision tree from the root node to a leaf node that indicates the desired result. For example, a decision tree traversal starting from root node 402 may proceed to nodes 404, 408, 412 to reach a result of “Likely Synthetic”. Such a traversal results in the rule: ‘Community size>=3 AND No individual mortgage tradeline AND FICO>700’.

In some embodiments, leaf nodes 406, 410, 412, 414 are associated with a probability value. The probability value indicates a probability that the identity is a synthetic identity. For example, node 412 may be associated with a probability of ‘0.9’ that indicates a 90% likelihood that the identity being evaluated by the rules of the graph is a synthetic identity. In different rule configurations, the probability values may change. In various embodiments, when the probability that an identity is a synthetic identity is greater than a threshold value, then it is determined that the identity is a synthetic identity.

In an embodiment, a second machine learning model is trained using the first set of rules and the targets from the training dataset. The rules from the first set of rules may be used as features for training the second machine learning model. An algorithm used to train the second machine learning model may comprise a logistic regression (LR) algorithm. The second machine learning model is used to generate a second set of rules. The second set of rules comprises a subset of rules from the first set of rules that are identified as being the most important rules for making accurate synthetic identity predictions. The second set of rules is optimized for evaluating the graph to detect synthetic identities. For example, a trained LR model generates weights associated with each rule that are used as features for training the LR model. Rules having a weight of 0 or a weight below a specified threshold may not be included in the second set of rules. In one embodiment, a rule importance metric can be calculated based on the generated weights of each rule. The rule importance metric can be used as a basis for deciding which rules from the first set of rules to include in the second set of rules.

In some embodiments, a RuleFit model may be used to perform the techniques described above. Technical details and examples of RuleFit are taught in the related reference “RuleFit,” at https://scikit- https://christophm.github.io/interpretable-ml-book/rulefit.html. Additionally, technical details and examples of LR are taught in the related reference “Logistic Regression,” at https://scikit-learn. org/stable/modules/generated/sklearn.linear_model.LogisticRegression.html.

In an embodiment, the second machine learning model is trained using the following hyperparameters: penalty: l1, dual=False, to1=0.0001, C=1.0, fit intercept: True, intercept_scaling: 1, class_weight: {0:1, 1:balanced_wt}, random_state: 0, solver: liblinear, max_iter: 1000, multi_class: auto, verbose: 0, warm_start: False, n_jobs: None, l1_ratio: None.

In some embodiments, the second set of rules can be further modified or adjusted using domain knowledge to produce enhanced rules that can identify synthetic identities with high accuracy.

In step 214, the second set of rules is evaluated against the graph to determine whether an identity represented by one or more nodes of the plurality of nodes in the graph is a synthetic identity. As an example, the second set of rules may include the rules: (a) No individual mortgage tradeline (b) Individual auto tradelines <2 (c) FICO>600. When determining whether an identity represented by a particular node in the graph is a synthetic identity, the rules may be applied against data associated with the graph, including data associated with a community of shared tradelines, specific tradeline attributes, personal identity information associated with each node, or any other information associated with a tradeline or community of shared tradelines. The rules may also be applied against any graph metrics associated with the community of shared tradelines. In this example, rule (a) is evaluated by traversing the graph to determine if there are any individual mortgage tradelines represented by edges in the graph. Rule (b) is evaluated by traversing the graph to determine if there are less than two individual auto tradelines represented by edges in the graph. Rule (c) is evaluated by querying for the personal identity information associated with the node being evaluated to determine if the FICO score of identity represented by the node is >600. When rules a, b, and c are satisfied, it is determined that the identity represented by the node is a synthetic identity.

In some embodiments, when rules a, b, and c from the above example are satisfied, the identity represented by the node is classified as a low risk of being associated with a synthetic identity. A ‘low risk’ classification may correspond to a likelihood or probability that that the identity is a synthetic identity. For example, a node classified as ‘low risk’ may correspond to a 60% likelihood that the identity represented by the node is a synthetic identity.

In another example, the second set of rules may include the rules (a) Community size >=3 nodes (b) No individual mortgage tradeline (c) FICO>700. When rules a, b, and c are satisfied, it is determined that the identity represented by the node is a synthetic identity. In this example, when rules a, b, and c are satisfied, it is determined that the identity represented by the node is a synthetic identity. In some embodiments, when the rules a, b, c from the above example are satisfied, the identity represented by the node is classified as a medium risk of being associated with a synthetic identity. A ‘medium risk’ classification may correspond to a likelihood or probability that the identity is a synthetic identity. For example, a node classified as ‘medium risk’ may correspond to an 85% likelihood that the identity represented by the node is a synthetic identity.

In another example, the second set of rules may include the rules (a) Community size >=3 nodes (b) No individual mortgage tradeline (c) At least 1 individual auto tradeline (d) At least one initial authorized tradeline (e) FICO>650 (f) Length of credit profile <=5 years. In this example, when rules a, b, c, and d are satisfied, it is determined that the identity represented by the node is a synthetic identity. In some embodiments, when the rules a, b, c, and d from the above example are satisfied, the identity represented by the node is classified as a high risk of being associated with a synthetic identity. A ‘high risk’ classification may correspond to a likelihood or probability that the identity is a synthetic identity. For example, a node classified as ‘high risk’ may correspond to a 99% likelihood that the identity represented by the node is a synthetic identity.

In various embodiments, when the probability or likelihood that an identity is a synthetic identity is greater than a threshold value, then it is determined that the identity is a synthetic identity. Such threshold values may be provided by administrators and may change over time.

In some embodiments, examples of rules or criteria that may be evaluated against data associated with a graph include, but are not limited to: a number of different tradelines shared in a community, a ratio of households versus an overall number of members in a community, a time difference between an oldest tradeline in a community and a second oldest tradeline in the community, a geographic spread of tradelines in a community, a shared home address across the tradelines in a community, a common past employment across the tradelines in a community, a speed at which community members are applying for loans or other tradelines at a given financial institution, an uneven key financial metric distribution compared to an overall random sample of people in a lending institution portfolio, and/or an elevated activity on a majority of the tradelines during a specific time period in a community. Rules may be evaluated in any number of other ways to determine that a community of shared tradelines may be associated with a synthetic identity.

The second set of rules supplied by the set of machine learning models provide optimal efficiency when traversing graphs that represent communities of shared tradelines. The second set of rules is optimized such that a minimum number of generated rules are required to be applied against a graph to accurately detect synthetic identities. For example, a set of rules, such as the second set of rules discussed herein, is optimized to detect synthetic identities in a graph at a higher accuracy metric than previous implementations. Additionally, the second set of rules is optimized such that fewer rules are required to be applied to the graph to achieve the same or greater synthetic identity detection accuracy compared to previous implementations. For example, a second set of rules that includes four rules can be applied against a graph to detect a 90% likelihood that an identity is synthetic. Previous implementations require applying 20 or 30 rules against the same data to achieve the same synthetic identity detection accuracy as the second set of rules. By applying fewer rules against graph data structures to achieve highly accurate results, these techniques reduce the usage of computing power, memory, and/or bandwidth required to traverse the graphs and detect synthetic identities. Thus, these techniques provide a technical improvement of conserving computing resources because fewer rules are applied to achieve the same or greater synthetic identity detection rates as previous techniques.

In an embodiment, a blacklist of potential synthetic identities is created based on the determining that an identity represented by one or more nodes of the plurality of nodes in the graph is a synthetic identity. For example, when it is determined that an identity associated with a node is or may be a synthetic identity, the personal identity information associated with the identity is added to a blacklist of potential synthetic identities. The blacklist may be used to perform various operations, such as causing the approval or denial of lines of credit or loans, as further discussed herein.

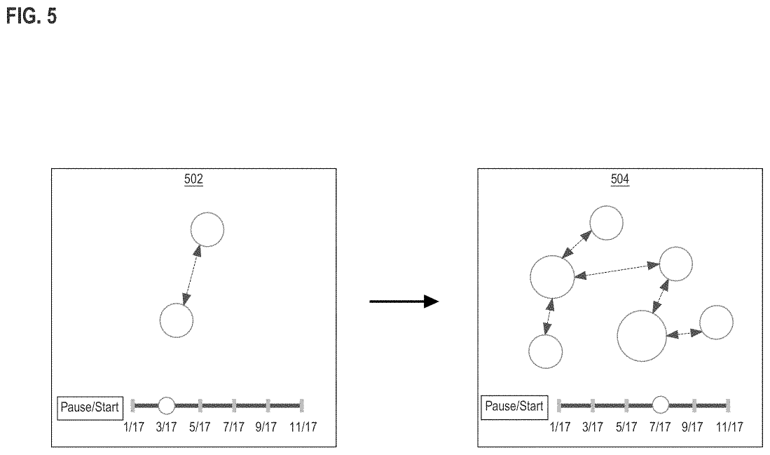

In some embodiments, the chronological development of a community of shared tradelines may be graphically visualized through a graphic visualization interface. FIG. 5 illustrates a graphical user interface (GUI) that depicts the chronological development of a community of shared tradelines. Each graphic 502, 504 represents a point in time screenshot of a time-lapse video that demonstrates a graphic visualization of the chronological development of a community of shared tradelines. The time-lapse video can be started and paused by selecting the ‘Pause/Start’ button as shown in each of the graphics 502, 504. In this example, Graphic 502 illustrates the community of shared tradelines at ‘3/17’, i.e. Mar. 17, 2017. Graphic 504 illustrates the community of shares tradelines at ‘7'17’, i.e. Jul. 17, 2017. As shown in graphic 502, on the date ‘3/17’ there are two nodes that share an edge in the community. Each node represents an identity. Each edge represents a tradeline that is shared between two identities. As the time-lapse video progresses to graphic 504, on the date ‘7/17’ there are six nodes where each node shares at least one edge with another node.

The time-lapse video assists administrators with identifying clusters of shared tradelines that may indicate fraudulent activity, such as the use of synthetic identities. While observing the time-lapse video, an administrator is able to quickly identify whether the behavior of a tradeline or a community of shared tradelines is standard or atypical.

The standard behavior of a tradeline is that, over a period of time, a tradeline associated with an identity is shared with at most, one or two other identities. For example, a parent represented by a first identity who has a credit account may add their child, who is represented by a second identity, as an authorized user of the credit account. By authorizing the child to use the credit account, the tradeline associated with the credit account is shared between the parent identity and the child identity. Thus, it is not unusual for a tradeline to be shared between one or two identities. Graphic 502 represents the standard behavior of a tradeline.

Atypical behavior of a tradeline is that, over a period of time, a tradeline associated with an identity is shared with three or more identities. For example, a first identity associated with a credit account may add a second identity associated with a synthetic identity as an authorized user of the credit account. While the synthetic identity builds credit by virtue of being adding to the first identity's credit account, the synthetic identity may then open another credit account or be added to a second identity's credit account. The process repeats until the synthetic identity builds a strong credit profile and is able to open multiple accounts with high lines of credit. By authorizing the synthetic identity to use the multiple credit accounts and opening new credit accounts as the credit profile associated with the synthetic identity is built, a web or community of shared tradelines is constructed that represents the fraudulent behavior. Graphic 504 represents the atypical behavior of a tradeline.

As an administrator observes the time-lapse video transition from graphic 502 to graphic 504, the community of shared tradelines undergoes a rapid expansion from two nodes to six nodes. Such a rapid expansion of a community of shared tradelines in indicative of fraudulent activity such as one or more of the tradelines in the community is associated with a synthetic identity.

Without the graphic visualization, an administrator would have to analyze a vast amount of tradeline data points that exist over large periods of time to identify potential synthetic identities. Thus, the GUI provides a unique visualization of shared data points that allows administrators to quickly and accurately identify fraudulent activity associated with financial institution accounts.

In step 216, in response to determining that the identity represented by one or more nodes of the plurality of nodes in the graph is a synthetic identity, a line of credit or loan associated with a financial institution account is caused to be denied or restricted. For example, an individual associated with an identity may open a financial institution account with a financial institution server 112 and apply for a line of credit or loan with the financial institution server 112. During the application process, the financial institution server 112 may issue a request to verify the authenticity of the identity associated with the financial institution account that is applying for the line of credit from fraud detection and prevention server 106. Such a request may include personal identity information associated with the identity or any other credentials associated with the identity that are used to apply for the line of credit or loan. In response, fraud detection and prevention server 106 may query a blacklist of potential synthetic identities to determine if the personal identity information included in the verification request matches any personal identity information included in the blacklist. In response to determining that the personal identity information included in the request does not match any information included in the blacklist, fraud detection and prevention server 106 may transmit a response to the request to the financial institution server 112 that programmatically causes the line of credit for the financial institution account to be approved. In response to determining that the personal identity information included in the request matches information included in the blacklist, fraud detection and prevention server 106 may transmit a response to the request to the financial institution server 112 that programmatically causes the line of credit for the financial institution account to be denied.

In another embodiment, a message, notification, or alert that indicates that a financial institution account is or may be associated with a synthetic identity may be transmitted. For example, a message, notification, or alert may be sent to financial institution server 112 that indicates that a financial institution account associated with the financial institution server 112 is or may be associated with a synthetic identity. In some embodiments, the message, notification, or alert may programmatically cause the financial institution server 112 to cease or restrict any lines of credit or loans that are associated with the financial institution account. In some embodiments, the message, notification, or alert may programmatically cause the financial institution server 112 to cease or restrict any lines of credit that are associated with the financial institution account.

Techniques discussed herein leverage tradeline and related tradeline data from multiple credit bureaus. In the past, such datasets have not been combined as a prerequisite to identifying fraudulent activity such as synthetic identities. The combination of datasets of multiple credit reporting bureaus allows more synthetic identities to be detected with a higher accuracy metric than previous techniques.

Techniques discussed herein provide graphical user interfaces (GUIs) that allow administrators to quickly and efficiently detect identities of tradelines that may be associated with synthetic identities. For example, graphic visualizations of communities of shared tradelines assist administrators in identifying potential clusters of fraudulent activity. As another example, time-lapse videos that depict the chronological development of communities of shared tradelines allow administrators to visualize community development over a period of time, providing administrators with further information to help identify fraudulent activity. Such GUIs provide unique and unconventional ways to filter, consolidate, and display vast amounts of data in a consolidated format so that administrators are able to quickly identify fraudulent patterns in the data that they normally would not be able to process or detect.

Techniques discussed herein provide procedures based on machine learning to generate optimized sets of rules that can be used to efficiently traverse graph data structures representing communities of shared tradelines to detect synthetic identities with improved speed and higher accuracy compared to previous techniques. The sets of rules are optimized such that fewer rules are required to be applied to the graph to achieve the same or greater synthetic identity detection accuracy compared to prior art approaches. For example, a set of rules that is optimized may include 4 rules that can be applied against a graph to detect a 90% likelihood that an identity is synthetic. Previous implementations require applying 20 or 30 rules against the same graph to achieve the same synthetic identity detection accuracy as the set of rules that is optimized. By applying fewer rules against the graph data structures to achieve the same or improved results, these techniques reduce the usage of computing power, memory, and/or bandwidth that prior art approaches required to perform such operations.

Thus, using the above-discussed techniques, the technical field of fraud detection and prevention is improved.

### 4. IMPLEMENTATION EXAMPLE—HARDWARE OVERVIEW

According to one embodiment, the techniques described herein are implemented by at least one computing device. The techniques may be implemented in whole or in part using a combination of at least one server computer and/or other computing devices that are coupled using a network, such as a packet data network. The computing devices may be hard-wired to perform the techniques, or may include digital electronic devices such as at least one application-specific integrated circuit (ASIC) or field programmable gate array (FPGA) that is persistently programmed to perform the techniques, or may include at least one general-purpose hardware processor programmed to perform the techniques pursuant to program instructions in firmware, memory, other storage, or a combination. Such computing devices may also combine custom hard-wired logic, ASICs, or FPGAs with custom programming to accomplish the described techniques. The computing devices may be server computers, workstations, personal computers, portable computer systems, handheld devices, mobile computing devices, wearable devices, body-mounted or implantable devices, smartphones, smart appliances, internetworking devices, autonomous or semi-autonomous devices such as robots or unmanned ground or aerial vehicles, any other electronic device that incorporates hard-wired and/or program logic to implement the described techniques, one or more virtual computing machines or instances in a data center, and/or a network of server computers and/or personal computers.

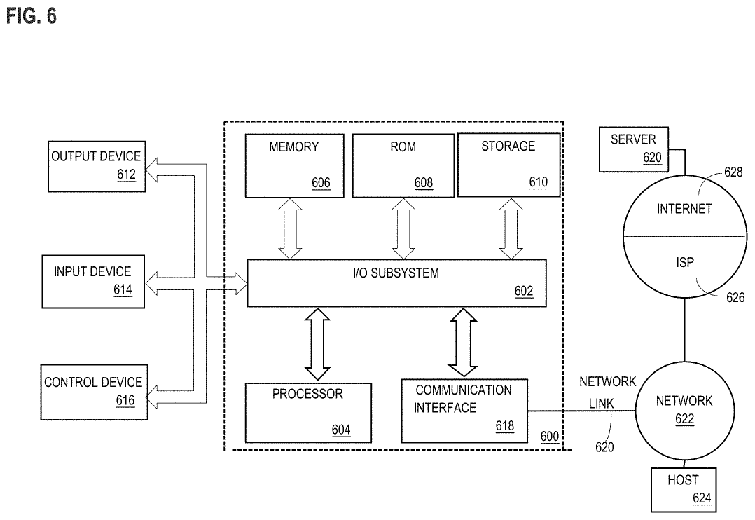

FIG. 6 is a block diagram that illustrates an example computer system with which an embodiment may be implemented.

In the example of FIG. 6, a computer system 600 and instructions for implementing the disclosed technologies in hardware, software, or a combination of hardware and software, are represented schematically, for example as boxes and circles, at the same level of detail that is commonly used by persons of ordinary skill in the art to which this disclosure pertains for communicating about computer architecture and computer systems implementations.

Computer system 600 includes an input/output (I/O) subsystem 602 which may include a bus and/or other communication mechanism(s) for communicating information and/or instructions between the components of the computer system 600 over electronic signal paths. The I/O subsystem 602 may include an I/O controller, a memory controller and at least one I/O port. The electronic signal paths are represented schematically in the drawings, for example as lines, unidirectional arrows, or bidirectional arrows.

At least one hardware processor 604 is coupled to I/O subsystem 602 for processing information and instructions. Hardware processor 604 may include, for example, a general-purpose microprocessor or microcontroller and/or a special-purpose microprocessor such as an embedded system or a graphics processing unit (GPU) or a digital signal processor or ARM processor. Processor 604 may comprise an integrated arithmetic logic unit (ALU) or may be coupled to a separate ALU.

Computer system 600 includes one or more units of memory 606, such as a main memory, which is coupled to I/O subsystem 602 for electronically digitally storing data and instructions to be executed by processor 604. Memory 606 may include volatile memory such as various forms of random-access memory (RAM) or other dynamic storage device. Memory 606 also may be used for storing temporary variables or other intermediate information during execution of instructions to be executed by processor 604. Such instructions, when stored in non-transitory computer-readable storage media accessible to processor 604, can render computer system 600 into a special-purpose machine that is customized to perform the operations specified in the instructions.

Computer system 600 further includes non-volatile memory such as read-only memory (ROM) 608 or other static storage device coupled to I/O subsystem 602 for storing information and instructions for processor 604. The ROM 608 may include various forms of programmable ROM (PROM) such as erasable PROM (EPROM) or electrically erasable PROM (EEPROM). A unit of persistent storage 610 may include various forms of non-volatile RAM (NVRAM), such as FLASH memory, or solid-state storage, magnetic disk or optical disks such as CD-ROM or DVD-ROM and may be coupled to I/O subsystem 602 for storing information and instructions. Storage 610 is an example of a non-transitory computer-readable medium that may be used to store instructions and data which when executed by the processor 604 cause performing computer-implemented methods to execute the techniques herein.

The instructions in memory 606, ROM 208 or storage 610 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. The instructions may implement a web server, web application server or web client. The instructions may be organized as a presentation layer, application layer and data storage layer such as a relational database system using structured query language (SQL) or no SQL, an object store, a graph database, a flat file system or other data storage.

Computer system 600 may be coupled via I/O subsystem 602 to at least one output device 612. In one embodiment, output device 612 is a digital computer display. Examples of a display that may be used in various embodiments include a touch screen display or a light-emitting diode (LED) display or a liquid crystal display (LCD) or an e-paper display. Computer system 600 may include other type(s) of output devices 612, alternatively or in addition to a display device. Examples of other output devices 612 include printers, ticket printers, plotters, projectors, sound cards or video cards, speakers, buzzers or piezoelectric devices or other audible devices, lamps or LED or LCD indicators, haptic devices, actuators or servos.

At least one input device 614 is coupled to I/O subsystem 602 for communicating signals, data, command selections or gestures to processor 604. Examples of input devices 614 include touch screens, microphones, still and video digital cameras, alphanumeric and other keys, keypads, keyboards, graphics tablets, image scanners, joysticks, clocks, switches, buttons, dials, slides, and/or various types of sensors such as force sensors, motion sensors, heat sensors, accelerometers, gyroscopes, and inertial measurement unit (IMU) sensors and/or various types of transceivers such as wireless, such as cellular or Wi-Fi, radio frequency (RF) or infrared (IR) transceivers and Global Positioning System (GPS) transceivers.

Another type of input device is a control device 616, which may perform cursor control or other automated control functions such as navigation in a graphical interface on a display screen, alternatively or in addition to input functions. Control device 616 may be a touchpad, a mouse, a trackball, or cursor direction keys for communicating direction information and command selections to processor 604 and for controlling cursor movement on display 612. The input device may have at least two degrees of freedom in two axes, a first axis (e.g., x) and a second axis (e.g., y), that allows the device to specify positions in a plane. Another type of input device is a wired, wireless, or optical control device such as a joystick, wand, console, steering wheel, pedal, gearshift mechanism or other type of control device. An input device 614 may include a combination of multiple different input devices, such as a video camera and a depth sensor.

In another embodiment, computer system 600 may comprise an internet of things (IoT) device in which one or more of the output device 612, input device 614, and control device 616 are omitted. Or, in such an embodiment, the input device 614 may comprise one or more cameras, motion detectors, thermometers, microphones, seismic detectors, other sensors or detectors, measurement devices or encoders and the output device 612 may comprise a special-purpose display such as a single-line LED or LCD display, one or more indicators, a display panel, a meter, a valve, a solenoid, an actuator or a servo.

When computer system 600 is a mobile computing device, input device 614 may comprise a global positioning system (GPS) receiver coupled to a GPS module that is capable of triangulating to a plurality of GPS satellites, determining and generating geo-location or position data such as latitude-longitude values for a geophysical location of the computer system 600. Output device 612 may include hardware, software, firmware and interfaces for generating position reporting packets, notifications, pulse or heartbeat signals, or other recurring data transmissions that specify a position of the computer system 600, alone or in combination with other application-specific data, directed toward host 624 or server 630.

Computer system 600 may implement the techniques described herein using customized hard-wired logic, at least one ASIC or FPGA, firmware and/or program instructions or logic which when loaded and used or executed in combination with the computer system causes or programs the computer system to operate as a special-purpose machine. According to one embodiment, the techniques herein are performed by computer system 600 in response to processor 604 executing at least one sequence of at least one instruction contained in main memory 606. Such instructions may be read into main memory 606 from another storage medium, such as storage 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage 610. Volatile media includes dynamic memory, such as memory 606. Common forms of storage media include, for example, a hard disk, solid state drive, flash drive, magnetic data storage medium, any optical or physical data storage medium, memory chip, or the like.

Storage media is distinct from but may be used in conjunction with transmission media. Transmission media participates in transferring information between storage media. For example, transmission media includes coaxial cables, copper wire and fiber optics, including the wires that comprise a bus of I/O subsystem 602. Transmission media can also take the form of acoustic or light waves, such as those generated during radio-wave and infra-red data communications.

Various forms of media may be involved in carrying at least one sequence of at least one instruction to processor 604 for execution. For example, the instructions may initially be carried on a magnetic disk or solid-state drive of a remote computer. The remote computer can load the instructions into its dynamic memory and send the instructions over a communication link such as a fiber optic or coaxial cable or telephone line using a modem. A modem or router local to computer system 600 can receive the data on the communication link and convert the data to a format that can be read by computer system 600. For instance, a receiver such as a radio frequency antenna or an infrared detector can receive the data carried in a wireless or optical signal and appropriate circuitry can provide the data to I/O subsystem 602 such as place the data on a bus. I/O subsystem 602 carries the data to memory 606, from which processor 604 retrieves and executes the instructions. The instructions received by memory 606 may optionally be stored on storage 610 either before or after execution by processor 604.

Computer system 600 also includes a communication interface 618 coupled to bus 602. Communication interface 618 provides a two-way data communication coupling to network link(s) 620 that are directly or indirectly connected to at least one communication networks, such as a network 622 or a public or private cloud on the Internet. For example, communication interface 618 may be an Ethernet networking interface, integrated-services digital network (ISDN) card, cable modem, satellite modem, or a modem to provide a data communication connection to a corresponding type of communications line, for example an Ethernet cable or a metal cable of any kind or a fiber-optic line or a telephone line. Network 622 broadly represents a local area network (LAN), wide-area network (WAN), campus network, internetwork or any combination thereof. Communication interface 618 may comprise a LAN card to provide a data communication connection to a compatible LAN, or a cellular radiotelephone interface that is wired to send or receive cellular data according to cellular radiotelephone wireless networking standards, or a satellite radio interface that is wired to send or receive digital data according to satellite wireless networking standards. In any such implementation, communication interface 618 sends and receives electrical, electromagnetic or optical signals over signal paths that carry digital data streams representing various types of information.

Network link 620 typically provides electrical, electromagnetic, or optical data communication directly or through at least one network to other data devices, using, for example, satellite, cellular, Wi-Fi, or BLUETOOTH technology. For example, network link 620 may provide a connection through a network 622 to a host computer 624.

Furthermore, network link 620 may provide a connection through network 622 or to other computing devices via internetworking devices and/or computers that are operated by an Internet Service Provider (ISP) 626. ISP 626 provides data communication services through a world-wide packet data communication network represented as internet 628. A server computer 630 may be coupled to internet 628. Server 630 broadly represents any computer, data center, virtual machine or virtual computing instance with or without a hypervisor, or computer executing a containerized program system such as DOCKER or KUBERNETES. Server 630 may represent an electronic digital service that is implemented using more than one computer or instance and that is accessed and used by transmitting web services requests, uniform resource locator (URL) strings with parameters in HTTP payloads, API calls, app services calls, or other service calls. Computer system 600 and server 630 may form elements of a distributed computing system that includes other computers, a processing cluster, server farm or other organization of computers that cooperate to perform tasks or execute applications or services. Server 630 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. Server 630 may comprise a web application server that hosts a presentation layer, application layer and data storage layer such as a relational database system using structured query language (SQL) or no SQL, an object store, a graph database, a flat file system or other data storage.

Computer system 600 can send messages and receive data and instructions, including program code, through the network(s), network link 620 and communication interface 618. In the Internet example, a server 630 might transmit a requested code for an application program through Internet 628, ISP 626, local network 622 and communication interface 618. The received code may be executed by processor 604 as it is received, and/or stored in storage 610, or other non-volatile storage for later execution.

The execution of instructions as described in this section may implement a process in the form of an instance of a computer program that is being executed and consisting of program code and its current activity. Depending on the operating system (OS), a process may be made up of multiple threads of execution that execute instructions concurrently. In this context, a computer program is a passive collection of instructions, while a process may be the actual execution of those instructions. Several processes may be associated with the same program; for example, opening up several instances of the same program often means more than one process is being executed. Multitasking may be implemented to allow multiple processes to share processor 604. While each processor 604 or core of the processor executes a single task at a time, computer system 600 may be programmed to implement multitasking to allow each processor to switch between tasks that are being executed without having to wait for each task to finish. In an embodiment, switches may be performed when tasks perform input/output operations, when a task indicates that it can be switched, or on hardware interrupts. Time-sharing may be implemented to allow fast response for interactive user applications by rapidly performing context switches to provide the appearance of concurrent execution of multiple processes simultaneously. In an embodiment, for security and reliability, an operating system may prevent direct communication between independent processes, providing strictly mediated and controlled inter-process communication functionality.

### 5. ADDITIONAL DISCLOSURE

Additional aspects of the subject matter described herein are set out in the following numbered clauses:

1. A computer system comprising: one or more processors; one or more memories storing instructions which, when executed by the one or more processors, cause: receiving electronically transmitted credit bureau report data, the credit bureau report data comprising a plurality of credit bureau reports that include data associated with a plurality of tradelines comprising at least a first tradeline associated with a first identity and a second tradeline associated with a second identity; receiving attributes associated with the plurality of tradelines, the attributes including attributes associated with the first tradeline and attributes associated with the second tradeline; determining one or more matches between attributes associated with the plurality of tradelines, the one or more matches including a match between attributes associated with the first tradeline and attributes associated with the second tradeline; generating and storing in memory, under program control, a graph data structure (graph) based on the one or more matches between attributes associated with the plurality of tradelines, the graph representing a first community of shared tradelines, each node of a plurality of nodes in the graph representing an identity and each edge of the graph representing a tradeline; creating a training dataset comprising attributes associated with tradelines, graph metrics relating to communities of shared tradelines, personal identity information relating to specific individuals, and default data; training a set of machine learning models using the training dataset, the trained set of machine learning models providing a set of rules that is optimized to detect synthetic identities in the graph; evaluating the set of rules against the graph to determine whether an identity represented by one or more nodes of the plurality of nodes in the graph is a synthetic identity; in response to determining that the identity represented by one or more nodes of the plurality of nodes in the graph is a synthetic identity, causing restricting or denying a line of credit or loan associated with a financial institution account.

2. The system of clause 1, wherein the data associated with a plurality of tradelines comprises a third tradeline that is associated with the first identity, the third tradeline received from a different credit reporting bureau than the first tradeline; wherein the system further comprises combining the first tradeline and third tradeline into a single dataset that is associated with the first identity.

3. The system of clause 1, wherein the attributes associated with the first tradeline and attributes associated with the second tradeline comprise at least one of: an account number, an account open date, a financial institution name, an account type, a high credit amount, a credit limit, and an equal credit opportunity act designator.

4. The system of clause 1, the instructions, when executed by the one or more processors, cause: traversing the graph to determine that two nodes of the plurality of nodes that share a particular edge in the graph are associated with the same personal identity information including last name or address; removing the particular edge from the graph.

5. The system of clause 1, the instructions, when executed by the one or more processors, cause: generating a graphical user interface (GUI), the GUI comprising a graphical visualization of the first community of shared tradelines, the graphical visualization including a plurality of nodes that each represent an identity and one or more edges between nodes of the plurality of nodes, each edge of the one or more edges representing a match of the one or more matches between attributes associated with the plurality of tradelines.

6. The system of clause 1, wherein training a set of machine learning models using the training dataset comprises: training a first machine learning model using the training dataset, the trained first machine learning model providing an ensemble of decision trees; extracting an first set of rules from the ensemble of decision trees; training a second machine learning model using the first set of rules; generating the second set of rules based on the trained second machine learning model.

7. The system of clause 1, wherein the training dataset comprises one or more features including: size of a community of shared tradelines, a number of mortgage tradelines associated with a node, a number of auto tradelines associated with a node, a number of total authorized tradelines associated with a node, a number of initial authorized tradelines associated with a node, a number of total individual tradelines associated with a node, a number of initial individual tradelines associated with a node, a number of inquiries on tradelines of type “Personal Finance” associated with a node, a number of distinct SSN associated with a node associated with a node, FICO score associated with a node, an average limit on initial authorized tradelines associated with a node, a depth of credit profile associated with a node, a debt to income ratio associated with a node, a payment to income ratio associated with a node, income associated with a node, utilization on tradelines of type “Revolving” associated with a node, a length of individual credit profile to length of complete credit profile ratio associated with a node. wherein the training dataset comprises one or more targets including an early term default value or charge off.

8. The system of clause 1, the instructions, when executed by the one or more processors, cause: in response to determining that an identity represented by a particular node of the plurality of nodes in the graph is a synthetic identity, adding personal identity information associated with the particular node to a blacklist of potential synthetic identities.

9. The system of clause 1, the instructions, when executed by the one or more processors, cause: generating a graphical user interface (GUI), the GUI comprising a graphical visualization of the first community of shared tradelines, the graphical visualization including time lapse video that depicts a chronological development of the first community of shared tradelines.

10. The system of clause 1, wherein causing restricting or denying a line of credit or loan associated with a financial institution account comprises: receiving a request to verify an identity associated with the financial institution account that is applying for the line of credit or loan, the request including personal identity information; determining that personal identity information included in the verification request matches personal identity information included in a blacklist, and in response, causing restricting or denying the line of credit or loan associated with the financial institution account.

11. A computer system comprising: one or more processors; one or more memories storing instructions which, when executed by the one or more processors, cause: receiving electronically transmitted credit bureau report data, the credit bureau report data comprising a plurality of credit bureau reports that include data associated with a plurality of tradelines comprising at least a first tradeline associated with a first identity and a second tradeline associated with a second identity; receiving attributes associated with the plurality of tradelines, the attributes including attributes associated with the first tradeline and attributes associated with the second tradeline; determining one or more matches between attributes associated with the plurality of tradelines, the one or more matches including a match between attributes associated with the first tradeline and attributes associated with the second tradeline; generating and storing in memory, under program control, a graph data structure (graph) based on the one or more matches between attributes associated with the plurality of tradelines, the graph representing a first community of shared tradelines, each node of a plurality of nodes in the graph representing an identity and each edge of the graph representing a tradeline; receiving a set of rules, the set of rules including one or more rules that are optimized using machine learning techniques to detect synthetic identities; evaluating the set of rules against the graph to determine whether an identity represented by one or more nodes of the plurality of nodes in the graph is a synthetic identity; in response to determining that the identity represented by one or more nodes of the plurality of nodes in the graph is a synthetic identity, causing restricting or denying a line of credit or loan associated with a financial institution account.

12. The system of clause 11, wherein the data associated with a plurality of tradelines comprises a third tradeline that is associated with the first identity, the third tradeline received from a different credit reporting bureau than the first tradeline; wherein the system further comprises combining the first tradeline and third tradeline into a single dataset that is associated with the first identity.

13. The system of clause 11, wherein the attributes associated with the first tradeline and attributes associated with the second tradeline comprise at least one of an account number, an account open date, a financial institution name, an account type, a high credit amount, a credit limit, and an equal credit opportunity act designator.

14. The system of clause 11, the instructions, when executed by the one or more processors, cause: traversing the graph to determine that two nodes of the plurality of nodes that share a particular edge in the graph are associated with the same personal identity information including last name or address; removing the particular edge from the graph.

15. The system of clause 11, the instructions, when executed by the one or more processors, cause: generating a graphical user interface (GUI), the GUI comprising a graphical visualization of the first community of shared tradelines, the graphical visualization including a plurality of nodes that each represent an identity and one or more edges between nodes of the plurality of nodes, each edge of the one or more edges representing a match of the one or more matches between attributes associated with the plurality of tradelines.

16. The system of clause 11, the instructions, when executed by the one or more processors, cause: in response to determining that an identity represented by a particular node of the plurality of nodes in the graph is a synthetic identity, adding personal identity information associated with the particular node to a blacklist of potential synthetic identities.

17. The system of clause 11, the instructions, when executed by the one or more processors, cause: generating a graphical user interface (GUI), the GUI comprising a graphical visualization of the first community of shared tradelines, the graphical visualization including time lapse video that depicts a chronological development of the first community of shared tradelines.

18. The system of clause 11, wherein causing restricting or denying a line of credit or loan associated with a financial institution account comprises: receiving a request to verify an identity associated with the financial institution account that is applying for the line of credit or loan, the request including personal identity information; determining that personal identity information included in the verification request matches personal identity information included in a blacklist, and in response, causing restricting or denying the line of credit or loan associated with the financial institution account.

19. A computer system comprising: one or more processors; one or more memories storing instructions which, when executed by the one or more processors, cause: creating a training dataset comprising attributes associated with tradelines, graph metrics relating to communities of shared tradelines, personal identity information relating to specific identities and default data; training a first machine learning model using the training dataset, the trained first machine learning model providing an ensemble of decision trees; extracting a first set of rules from the ensemble of decision trees; training a second machine learning model using the first set of rules; generating a second set of rules based on the trained second machine learning model.

20. The system of clause 19, wherein the training dataset comprises one or more features including: size of a community of shared tradelines, a number of mortgage tradelines associated with a node, a number of auto tradelines associated with a node, a number of total authorized tradelines associated with a node, a number of initial authorized tradelines associated with a node, a number of total individual tradelines associated with a node, a number of initial individual tradelines associated with a node, a number of inquiries on tradelines of type “Personal Finance” associated with a node, a number of distinct SSN associated with a node associated with a node, FICO score associated with a node, an average limit on initial authorized tradelines associated with a node, a depth of credit profile associated with a node, a debt to income ratio associated with a node, a payment to income ratio associated with a node, income associated with a node, utilization on tradelines of type “Revolving” associated with a node, a length of individual credit profile to length of complete credit profile ratio associated with a node.

21. The system of clause 19, wherein the training dataset comprises one or more targets including an early term default value or charge off.

22. The system of clause 19, wherein the first machine learning model is trained using a gradient boosting algorithm.

23. The system of clause 19, wherein the second machine learning model is trained using a logistic regression algorithm.

24. The system of clause 19, the instructions, when executed by the one or more processors, cause: using one or more weights that correspond to one or more features from the trained second machine learning model to generate the second set of rules.

25. The system of clause 19, wherein the first machine learning model is trained using hyperparameters including: loss: deviance, learning_rate: 0.1, n_estimators: 100, subsample: 1.0, criterion: friedman_mse, min_samples_split: 2, min_samples_leaf: 1, min_weight_fraction_leaf: 0.0, max_depth: 4, min_impurity_decrease: 0.0, min_impurity_split: None, init: None, random_state: None, max_features: None, verbose: 0, max_leaf nodes: None, warm_start: False, validation_fraction: 0.1, n_iter_no_change: None, tol: 0.0001, ccp_alpha: 0.0.

26. The system of clause 19, wherein the second machine learning model is trained using hyperparameters including: penalty: l1, dual=False, to1=0.0001, C=1.0, fit_intercept: True, intercept_scaling: 1, class_weight: {0:1, 1:balanced_wt}, random_state: 0, solver: liblinear, max_iter: 1000, multi_class: auto, verbose: 0, warm_start: False, n_jobs: None, l1 ratio: None.

27. The system of clause 19, wherein the first set of rules is extracted from the ensemble of decision trees by traversing each decision tree of the ensemble of decisions trees from a root node to a leaf node.

What is claimed is:

1. A computer-implemented method comprising:
receiving electronically transmitted credit bureau report data, the credit bureau report data comprising a plurality of credit bureau reports that include data associated with a plurality of tradelines comprising at least a first tradeline associated with a first identity and a second tradeline associated with a second identity;
receiving attributes associated with the plurality of tradelines, the attributes including attributes associated with the first tradeline and attributes associated with the second tradeline;
determining one or more matches between attributes associated with the plurality of tradelines, the one or more matches including a match between attributes associated with the first tradeline and attributes associated with the second tradeline;
generating and storing in memory, under program control, a graph data structure (graph) based on the one or more matches between attributes associated with the plurality of tradelines, the graph representing a first community of shared tradelines, each node of a plurality of nodes in the graph representing an identity and each edge of the graph representing a tradeline;
creating a training dataset comprising attributes associated with tradelines, graph metrics relating to communities of shared tradelines, personal identity information relating to specific individuals, and default data;
training a set of machine learning models using the training dataset, the trained set of machine learning models providing a set of rules that is optimized to detect synthetic identities in the graph;
evaluating the set of rules against the graph to determine whether an identity represented by one or more nodes of the plurality of nodes in the graph is a synthetic identity;
in response to determining that the identity represented by one or more nodes of the plurality of nodes in the graph is a synthetic identity, causing restricting or denying a line of credit or loan associated with a financial institution account.

2. The method of claim 1, wherein the data associated with a plurality of tradelines comprises a third tradeline that is associated with the first identity, the third tradeline received from a different credit reporting bureau than the first tradeline;
wherein the method further comprises combining the first tradeline and third tradeline into a single dataset that is associated with the first identity.

3. The method of claim 1, wherein the attributes associated with the first tradeline and attributes associated with the second tradeline comprise at least one of: an account number, an account open date, a financial institution name, an account type, a high credit amount, a credit limit, and an equal credit opportunity act designator.

4. The method of claim 1, further comprising:
traversing the graph to determine that two nodes of the plurality of nodes that share a particular edge in the graph are associated with the same personal identity information including last name or address;
removing the particular edge from the graph.

5. The method of claim 1, further comprising generating a graphical user interface (GUI), the GUI comprising a graphical visualization of the first community of shared tradelines, the graphical visualization including a plurality of nodes that each represent an identity and one or more edges between nodes of the plurality of nodes, each edge of the one or more edges representing a match of the one or more matches between attributes associated with the plurality of tradelines.

6. The method of claim 1, wherein training a set of machine learning models using the training dataset comprises:
training a first machine learning model using the training dataset, the trained first machine learning model providing an ensemble of decision trees;
extracting an first set of rules from the ensemble of decision trees;
training a second machine learning model using the first set of rules;
generating the second set of rules based on the trained second machine learning model.

7. The method of claim 1, wherein the training dataset comprises one or more features including: size of a community of shared tradelines, a number of mortgage tradelines associated with a node, a number of auto tradelines associated with a node, a number of total authorized tradelines associated with a node, a number of initial authorized tradelines associated with a node, a number of total individual tradelines associated with a node, a number of initial individual tradelines associated with a node, a number of inquiries on tradelines of type “Personal Finance” associated with a node, a number of distinct SSN associated with a node associated with a node, FICO score associated with a node, an average limit on initial authorized tradelines associated with a node, a depth of credit profile associated with a node, a debt to income ratio associated with a node, a payment to income ratio associated with a node, income associated with a node, utilization on tradelines of type “Revolving” associated with a node, a length of individual credit profile to length of complete credit profile ratio associated with a node.
wherein the training dataset comprises one or more targets including an early term default value or charge off.

8. The method of claim 1, further comprising: in response to determining that an identity represented by a particular node of the plurality of nodes in the graph is a synthetic identity, adding personal identity information associated with the particular node to a blacklist of potential synthetic identities.

9. The method of claim 1, further comprising generating a graphical user interface (GUI), the GUI comprising a graphical visualization of the first community of shared tradelines, the graphical visualization including time lapse video that depicts a chronological development of the first community of shared tradelines.

10. The method of claim 1, wherein causing restricting or denying a line of credit or loan associated with a financial institution account comprises:
receiving a request to verify an identity associated with the financial institution account that is applying for the line of credit or loan, the request including personal identity information;
determining that personal identity information included in the verification request matches personal identity information included in a blacklist, and in response, causing restricting or denying the line of credit or loan associated with the financial institution account.

11. A computer-implemented method comprising:
receiving electronically transmitted credit bureau report data, the credit bureau report data comprising a plurality of credit bureau reports that include data associated with a plurality of tradelines comprising at least a first tradeline associated with a first identity and a second tradeline associated with a second identity;
receiving attributes associated with the plurality of tradelines, the attributes including attributes associated with the first tradeline and attributes associated with the second tradeline;
determining one or more matches between attributes associated with the plurality of tradelines, the one or more matches including a match between attributes associated with the first tradeline and attributes associated with the second tradeline;
generating and storing in memory, under program control, a graph data structure (graph) based on the one or more matches between attributes associated with the plurality of tradelines, the graph representing a first community of shared tradelines, each node of a plurality of nodes in the graph representing an identity and each edge of the graph representing a tradeline;
receiving a set of rules, the set of rules including one or more rules that are optimized using machine learning techniques to detect synthetic identities;
evaluating the set of rules against the graph to determine whether an identity represented by one or more nodes of the plurality of nodes in the graph is a synthetic identity;
in response to determining that the identity represented by one or more nodes of the plurality of nodes in the graph is a synthetic identity, causing restricting or denying a line of credit or loan associated with a financial institution account.

12. The method of claim 11, wherein the data associated with a plurality of tradelines comprises a third tradeline that is associated with the first identity, the third tradeline received from a different credit reporting bureau than the first tradeline;
wherein the method further comprises combining the first tradeline and third tradeline into a single dataset that is associated with the first identity.

13. The method of claim 11, wherein the attributes associated with the first tradeline and attributes associated with the second tradeline comprise at least one of an account number, an account open date, a financial institution name, an account type, a high credit amount, a credit limit, and an equal credit opportunity act designator.

14. The method of claim 11, further comprising:
traversing the graph to determine that two nodes of the plurality of nodes that share a particular edge in the graph are associated with the same personal identity information including last name or address;
removing the particular edge from the graph.

15. The method of claim 11, further comprising generating a graphical user interface (GUI), the GUI comprising a graphical visualization of the first community of shared tradelines, the graphical visualization including a plurality of nodes that each represent an identity and one or more edges between nodes of the plurality of nodes, each edge of the one or more edges representing a match of the one or more matches between attributes associated with the plurality of tradelines.

16. The method of claim 11, further comprising: in response to determining that an identity represented by a particular node of the plurality of nodes in the graph is a synthetic identity, adding personal identity information associated with the particular node to a blacklist of potential synthetic identities.

17. The method of claim 11, further comprising generating a graphical user interface (GUI), the GUI comprising a graphical visualization of the first community of shared tradelines, the graphical visualization including time lapse video that depicts a chronological development of the first community of shared tradelines.

18. The method of claim 11, wherein causing restricting or denying a line of credit or loan associated with a financial institution account comprises:
receiving a request to verify an identity associated with the financial institution account that is applying for the line of credit or loan, the request including personal identity information;
determining that personal identity information included in the verification request matches personal identity information included in a blacklist, and in response, causing restricting or denying the line of credit or loan associated with the financial institution account.

19. A computer-implemented method comprising:
creating a training dataset comprising attributes associated with tradelines, graph metrics relating to communities of shared tradelines, personal identity information relating to specific identities and default data;
training a first machine learning model using the training dataset, the trained first machine learning model providing an ensemble of decision trees;
extracting a first set of rules from the ensemble of decision trees;
training a second machine learning model using the first set of rules;
generating a second set of rules based on the trained second machine learning model.

20. The method of claim 19, wherein the training dataset comprises one or more features including: size of a community of shared tradelines, a number of mortgage tradelines associated with a node, a number of auto tradelines associated with a node, a number of total authorized tradelines associated with a node, a number of initial authorized tradelines associated with a node, a number of total individual tradelines associated with a node, a number of initial individual tradelines associated with a node, a number of inquiries on tradelines of type “Personal Finance” associated with a node, a number of distinct SSN associated with a node associated with a node, FICO score associated with a node, an average limit on initial authorized tradelines associated with a node, a depth of credit profile associated with a node, a debt to income ratio associated with a node, a payment to income ratio associated with a node, income associated with a node, utilization on tradelines of type “Revolving” associated with a node, a length of individual credit profile to length of complete credit profile ratio associated with a node.

21. The method of claim 19, wherein the training dataset comprises one or more targets including an early term default value or charge off.

22. The method of claim 19, wherein the first machine learning model is trained using a gradient boosting algorithm.

23. The method of claim 19, wherein the second machine learning model is trained using a logistic regression algorithm.

24. The method of claim 19, further comprising:
using one or more weights that correspond to one or more features from the trained second machine learning model to generate the second set of rules.

25. The method of claim 19, wherein the first machine learning model is trained using hyperparameters including: loss: deviance, learning_rate: 0.1, n_estimators: 100, subsample: 1.0, criterion: friedman_mse, min_samples_split: 2, min_samples_leaf: 1, min_weight_fraction_leaf: 0.0, max_depth: 4, min_impurity_decrease: 0.0, min_impurity_split: None, init: None, random_state: None, max_features: None, verbose: 0, max_leaf_nodes: None, warm_start: False, validation_fraction: 0.1, n_iter_no_change: None, tol: 0.0001, ccp alpha: 0.0.

26. The method of claim 19, wherein the second machine learning model is trained using hyperparameters including: penalty: l1, dual=False, tol=0.0001, C=1.0, fit intercept: True, intercept_scaling: 1, class_weight: {0:1, 1:balanced_wt}, random_state: 0, solver: liblinear, max_iter: 1000, multi_class: auto, verbose: 0, warm_start: False, n_jobs: None, l1 ratio: None.

27. The method of claim 19, wherein the first set of rules is extracted from the ensemble of decision trees by traversing each decision tree of the ensemble of decisions trees from a root node to a leaf node.
